(19) United States
(12) Patent Application Publication
(10) Pub. No.: US 2022/0290419 A1
(43) Pub. Date: Sep. 15, 2022

(54) Drain Device and Shower Base System

(71) Applicant: Ardex, L.P., Aliquippa, PA (US)

(72) Inventors: Scott Carroll, Chattanooga, TN (US); John Timothy Erwin, Rossville, GA (US)

(21) Appl. No.: 17/196,782

(22) Filed: Mar. 9, 2021

(51) Int. Cl. E03C 1/20; E03F 5/04

(52) U.S. Cl. CPC E03C 1/20; E03F 5/0408; E03F 5/0409

(57) ABSTRACT

Provided are systems for and methods of providing an integrated drain system and shower base. The drain system comprises a bonding flange drain that has a flange defining a drain opening, a substrate encompassing the outer portion of the flange and supporting the flange, and a waterproof membrane having a fibrous surface. A bonding material couples the membrane to the substrate. A drain tube having an inner rim and operable to removably seal with the lower end of the bonding flange drain using a coupling interface that includes a silicon seal.

### TECHNICAL FIELD

This disclosure relates to the technical field of preformed shower bases and drains. More specifically, this disclosure relates to devices and systems for bases with integral formed drains with preformed sloped bases. Further, the shower system is directed towards base systems not requiring glue or other adhesives between the shower drain and a building's pre-plumbed-in wastewater pipe.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Generally, the present disclosure is directed to drain systems and drain systems with integrated shower bases. The system can include a bonding drain flange having a drain opening and a lower drain end. A substrate encompasses the flange and provides support for the bonding drain flange. Attached to the flange and surrounding the drain opening is a waterproof membrane. The membrane is bonded to the flange and substrate using a waterproof cement. A removable drain tube is configured to couple to the bottom of the bonding drain flange and provide a waterproof seal.

The base is preferably formed from a lightweight high-density foam which can include a graphite infused foam that provides for greater insulation. The waterproof material is preferably made from polypropylene. Further, each side of the polypropylene can include a fibrous layer that helps with the bonding between the waterproof membrane and the substrate. Additionally, on the opposing side the fibrous layer can help with the bonding of mortar and tiles to the opposing side of the waterproof membrane.

Further, the system can include a waste drain adaptor. The waste drain adaptor is configured to couple to the building's waste drainpipe and to the bottom of the drain tube.

Also disclosed is a method of making a drain and shower system. The method involves the forming of a substrate, preferably high-density graphite infused foam. The substrate can be formed to the size of a shower base and be sloped towards an opening where a bonding drain flange is to be installed. The drain opening where the bonding drain flange is to be installed should be configured to support the bonding drain flange around the flange.

Next, the bonding drain flange is bonded to the substrate with a waterproof adhesive. Over the substrate and up to the drain opening, a waterproof membrane is cemented to the substrate. The waterproof membrane can include a fibrous layer to help with the adhesion of the bonding agent.

Additionally, the system includes the forming of a drain tube configured to detachably couple to the bottom of the bonding drain flange that is bonded to the substrate. The coupling can be implemented by a silicon ring attached to the inner rim of the drain tube.

### BRIEF DESCRIPTION OF DRAWINGS

Exemplary embodiments are illustrated by way of example and not limitation in the figures of the accompanying drawings, in which like references indicate similar elements.

FIG. 1 is an exploded diagram showing the components of one embodiment of a shower drain system as described herein.

FIG. 2 is a diagram of the drain tube.

FIG. 3 is a flow chart of a method of making a shower base with an integral drain and waterproofing system.

### DETAILED DESCRIPTION OF EXEMPLARY EMBODIMENTS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

Shower enclosures are often installed after the drain flange has been installed. Preparing and tiling the enclosure currently requires the scheduling and use of multiple tradespeople. First a plumber needs to be scheduled to install the flange to a wastewater pipe. This needs to be straight and the correct height above the flooring structure. Next, a tradesperson is needed to prepare the pan. The preparation can require hundreds of pounds of cement and sand that needs to be sloped towards the drain. Additionally, the formed pan needs one or more water barriers to be made watertight. This can include a membrane under the formed cement pan and a sealant on top of the sloped cement pan. This process has its disadvantages and can be subject to many problems.

The first disadvantage is that a pan or bed is made of cement and sand. This material is heavy and can require the supporting structure to be reinforced. Secondly, the mixing of the cement and sand on-site can cause dust and expose workers and anyone around the worksite to the dust which can include harmful silica dust. Further, the shower bed is often sealed with a volatile material that outgasses toxic fumes.

Another disadvantage of the building of traditional shower beds is the time required for both the cement shower bed to dry and for the waterproofing to dry. The bed has to be formed and then given time to dry. Then the waterproofing is applied, it requires time to dry before tiling, and thus requires the scheduling of multiple tradespeople, and thereby adding time and cost to the schedule.

An additional disadvantage of the manual building of the cement shower bed is that it can be subject to variation. There is always the chance for error of making the slope too large or too small. This can be ascetically displeasing, cause problems for the person tiling, or not meet the building code. Thus, the shower bed would have to be redone and cause further delays.

Further, there is the possibility of imperfections in the application of the waterproofing sealant. These imperfections could allow water could penetrate the waterproof barrier and into the cement shower bed thereby causing leaks and subsequent damage to the supporting shower structure.

What is needed is a shower base and drain system that does not require a plumber, that can be installed without a plumber or gluing, that is fast to install and reliably provides a waterproof barrier, consistently provides a uniformly contoured surface for tile installation, and minimizes an installer's exposure to harmful dust and vapors.

The technology disclosed herein is concerned with an integrated shower base with an integrated drain and waterproofing system. Embodiments of the shower base and drain system disclose a system that addresses multiple issues with the fabrication, installation, and waterproofing of traditional shower bases and drains. The first issue is to provide a simple and fast to install shower base and drain by an individual that does not require special skills. Second, is a shower base and drain that reliability minimizes the possibility of leaks or moisture penetrating the base and thereby reaching substructures and causing subsequent damage. Thirdly, the disclosed shower base and drain system does not require to be professionally installed by a plumber thereby eliminating the scheduling and coordinating of multiple tradespeople required for prior shower installations. Other example embodiments of the disclosure and aspects will become apparent from the following description in conjunction with the drawings.

Referring now to the drawings, various embodiments are described in which like reference numerals represent like parts and assemblies throughout the several views. It should be noted that the reference to various embodiments does not limit the scope of the claims attached hereto. Additionally, any examples outlined in this specification are not intended to be limiting and merely set forth some of the many possible embodiments for the appended claims.

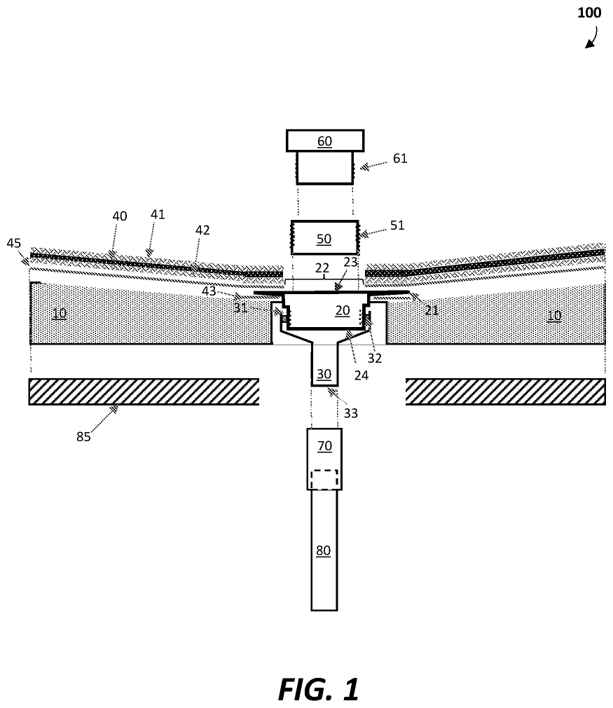

FIG. 1 shows a diagram of components of a shower base and drain 100 in relation to a building's floor structure 85 and a shower waste pipe 80. It should be noted, however, that the components and the orientation of the shower base, drain components, and shower waste pipe is just one example and is a simplified embodiment provided for illustrative purposes, and reasonable deviations of this embodiment are possible, including the absence of some of the components, as will be evident for those skilled in the art of mechanical design.

As shown in FIG. 1, the shower base and drain 100 can include a substrate 10, a bonding flange 20, a down tube 30, (shown coupled to the bonding flange 20), an adaptor 50, an adjustable drain 60, a waterproof barrier 40. The shower base and drain system 100 is configured to attach to a wastewater pipe 80 without requiring glue or a plumber to attach the system 100 to the wastewater pipe 80. The substrate 10, also referred to as the base 10 can be sized to fit within a shower enclosure, be pre-sloped from the edges to the drain, and rest on a floor sub-structure 85.

The bonding flange drain 20 includes a flange 21 that defines the drain surface 22. The drain surface 22 can extend to the edge of the flange 21. The flange 21 defines a drain opening aperture 23. The flange 21 can be fully or partially supported by the substrate 10. The flange 21 transfers any weight on the bonding flange drain 20 or flange 21 to the substrate 10 and accordingly, the flange 21 is sized to transfer an expected weight load without causing excessive flexing for the overlying tiles which could cause cracks in the tile gout and resulting leaks. Further, support for the flange 21 should be configured to prevent forces on the flange 21, or bonding flange drain 20, or adaptor 50, or drain 60, or their combination from damaging any of these components. Such a weight load could occur from a three hundred person using the shower. Thus, the denser and the more rigid the substrate 10, the smaller the flange can be. Additionally, the more the flange 21 is supported, the less flexing of the bonding flange drain 20 which could compromise the waterproof seal between the flange 21 and the substrate 10. One skilled in the art of mechanical design would be able to determine the size of the flange 21. The invention also contemplates parts other than the flange 21 of the bonding flange drain 20 being bonded to the substrate 10. Parts of the bonding flange drain 20 below the flange 21 could be bonded (not shown) to the substrate 10 creating additional support and waterproofing between the bonding flange drain 20 and the substrate 10.

The bonding flange drain 20 can be bonded to the substrate 10 around the flange 21 with an adhesive or polyurethane cement. The adhesive preferably forms a waterproof barrier between the flange 21 and the substrate 10. One suitable and commercially available waterproof adhesive is ARDEX CA 20 P™. However, other adhesives are contemplated.

Coupled to the substrate 10 and the flange 21 is a waterproof membrane 40. The waterproof membrane 40 is preferably coupled using an adhesive 45 which can include a waterproofing cement. Exemplar, of such waterproofing cement is the commercial product ARDEX 8+9™, a polyurethane cement. Preferably, the waterproof membrane 40 is seamless sheet that extends from the bonding flange drain hole 23 to the edges of the substrate 20. In some configurations the membrane 40 can extend beyond the substrate edges for the purpose of providing a waterproof connection between the floor and the wall of a shower enclosure.

To further assist with the bonding between the substrate 20 and the waterproof membrane 40, a fibrous layer 42 can be coupled or bonded to the bottom of the waterproof membrane 40. The fibrous layer 42 is provided to form a better bond between the waterproof membrane 40, the adhesive 45, and the substrate 10. The fibrous material can be made from synthetic materials or natural materials like wool. The fibrous material can be coupled with the waterproof membrane 40 with a waterproof adhesive, the fibrous material can be integrally formed into the membrane 40, it can be heat welded to the membrane 40 or a combination thereof. Further, the waterproof membrane 40 can include a fibrous material layer 41 coupled to the opposing top side. This fibrous layer 41 helps form a better bonding surface for mounting tile, marble, synthetic stone, and other natural stone using a thin set mortar or other adhesion means. The thickness of the fibrous material 41, 42 can vary between the top side and the bottom side of the membrane 40. Further, the density of the material 41, 42 can vary. Preferable the fibrous material 41, 42 allows the adhesive 45 on the bottom side and thin-set mortar on the top side to reach and bond to the waterproof membrane 40. One skilled in the art of manufacturing waterproof membranes would be able to choose a suitable fibrous material 41, 42 density and thickness. Typically, the thickness of the fibrous material is less than one quarter of an inch.

To further enhance a waterproof barrier between where the tile is coupled to the fibrous layer 41 on the top of the waterproof membrane 40, the adhesive 45 used to bond to the waterproof membrane 40 and to the fibrous layer 42 can be a waterproof cement. Preferably, this waterproof cement is polyurethane cement. An example of a commercially available product suitable for this purpose is the ARDEX 8+9™ adhesive cement. Though other adhesives are contemplated including but not limited to epoxies, polyimides, cyanoacrylates, and acrylic.

The system can include an adaptor 50 that couples with the bondable drain flange 20. The adaptor 10 can be used to connect different types of drain 60 to the drain system 100. The drain 60 can be of different sizes, shapes, and materials and thus the adaptor 50 can be used to couple the drain 60 with the system 100. The adaptor can include threads 51 configured to thread into the bonding flange drain 20.

The system can include a drain 60. The drain 60 is the part that is visible after the tile is installed. The drain 60 can include threads 61 on the outside that are adapted to couple with the adaptor 50 and are used to match the drain height with the height of the tile or marble. The drain 60 can include threads 61 and be configured to thread into the adaptor 50.

The system can include a wastewater adaptor 70. The adaptor 70 provides a watertight coupling between the bottom of the drain tube 30 and the wastewater pipe 80. Preferably, the wastewater adaptor 70 is a flexible sleeve that fits over the bottom end 33 of the drain tube 30 and the wastewater pipe 80. The benefit of a flexible and elastic wastewater adaptor 70 is that if the wastewater pipe 80 is not perfectly vertical, then adaptor 70 will flex to allow vertical alignment with the bottom of the lower drain end 33. Further, the substrate 10 that can be as big as the entire shower floor, can be placed over the wastewater adaptor 70 and pressed together to make a watertight connection.

The substrate 10 or base provides a uniformly sloped surface from the edges to the drain. Further, the substrate 10 provide support for the waterproof membrane 40, tile that are applied to the membrane 40, and any person standing on the substrate 10. Preferably the substrate 10 is made from a high-density rigid foam or a graphite infused foam. Foam has the advantages of being light. The shower drain system 100 can be light enough for a single person to handle its placement and installation. Another advantage of foam is that it is easy to trim, if needed, to fit a shower enclosure. A further advantage of foam is that it provides thermal insulation. The shower floor tile will warm up faster. The use of high density graphic infused foam has an increased R-value for even greater insulation.

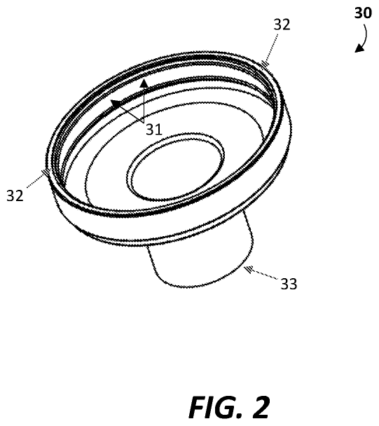

Referring to FIG. 2, a diagram of a drain tube 30 is shown and described. The drain tube 30 include an inner rim 31 configured to slide over the bottom end of the bonding flange drain 20. The drain tube 30 can include a seal 32 coupled to the inner rim 31. The seal 32 and inner rim 31 are configured to create a watertight connection with the bonding flange drain 20. Beneficial to this design is that the seal should never be under any hydrostatic pressure. Water from the drain opening 23 should flow out of the drain end and not reach the seal 32.

The seal 32 can be formed of silicon rubber or any other pliable material that is not degraded by water. The seal 32 can be heat bonded to the inner rim 31 or couple with an adhesive. Also contemplated is the inner rim 31 having a groove (not shown) in which the seal is pressed into.

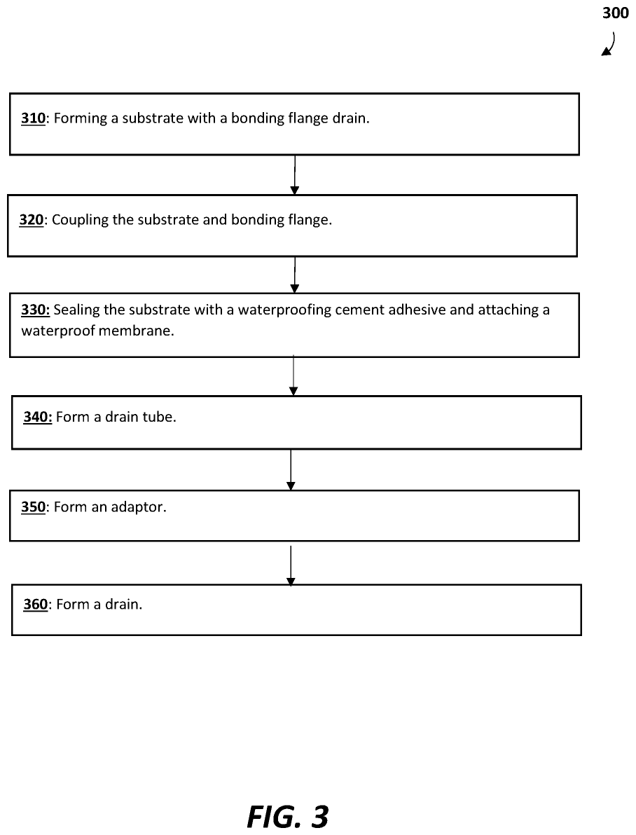

Referring to FIG. 3, a flow chart of a method of making a shower base with integral drain is shown and described.

In a step 310, a substrate is formed with a bonding flange drain. The formed substrate extends to encompass the outer portion of the flange and to provide support under the flange. The substrate can be sized as large as the shower floor. An aperture is formed to accommodate a bonding flange with supports for the flange to rest. One side is flat, and the other side is contoured to slope towards the aperture. The substrate can be made from high-density foam or graphite infused foam.

In a step 320, the bonding flange drain is coupled to the substrate with an adhesive. Preferably the adhesive is waterproof and the adhesive is placed between the flange and where it contacts the substrate.

In a step 330, a waterproofing cement is applied to the substrate and used to bond a waterproof membrane to the substrate. The waterproof membrane can be polypropylene and can have an attached or coupled fiber mesh to provide better adhesion between the substrate and the waterproof membrane. Further, the waterproof membrane can have fiber coupled to the top exposed side for better adhesion with a tile thin-set adhesive or mastic.

In a step 340, a drain tube is formed. It is configured with a ring coupled to the inside of the drain tube and sized to form a water-tight seal when slid over the bottom portion of the flange. The ring coupled to the inside of the drain can be a silicon material but other pliable material are contemplated.

In a step 350, an adaptor is formed that configured to be threaded inside the drain opening. Preferably, the adaptor is plastic, but other materials are contemplated including metal. The adaptor can include a weep line down the inside of the adaptor, the outside of the adaptor or both. A weep line is configured to carry water that might leak under grouted tile and instead of keeping the gout wet, it can reach and run down the drain.

In a step 360, a drain is formed. The drain can be formed out of metal or plastic. The drain is configured to thread into or otherwise couple with the adaptor and can have different shapes. The drain is also configured to have a sufficiently long threaded connector to be adjustable to accommodate different tile or shower floor thicknesses. The drain can include weep lines along the outside which allow water that has penetrated the grout to reach the drain.

What is claimed is:

1. A drain system comprising:
a bonding flange drain comprising a flange defining a drain surface and defining a drain opening, a lower drain end and a tubular structure between the drain opening and the lower drain end;
a substrate that encompasses the outer portion of the flange and extending under a portion of the flange;
a waterproofing membrane and a bonding material to couple a portion of the substrate and to the drain surface up to the boundary of the drain opening; and
a drain tube with an inner rim, the drain tube operable to removably seal with the lower end of the bonding flange drain using a coupling interface.

2. The system of claim 1, wherein the coupling interface is a silicon ring coupled to either the inside of the drain tube or the outside of the lower drain end.

3. The system of claim 1, wherein the waterproofing membrane is a polypropylene.

4. The system of claim 3, wherein the waterproofing membrane further includes a fibrous material mesh extending from both sides of the polypropylene.

5. The system of claim 4, wherein the bonding material is a waterproof polyurethane cement.

6. The system of claim 1, further comprising a waterproof adhesive bonding the flange to the substrate.

7. The system of claim 1, wherein the substrate is a rigid high-density foam.

8. The system of claim 7, wherein the ridged foam is a graphite infused polystyrene foam.

9. The shower drain system of claim 1 further comprising:
an adaptor threaded on the inside and outside configured to screw into the tubular structure; and
an adjustable drain configured to screw into the adaptor, wherein the bonding band includes a waste end positioned opposite the coupling interface.

10. The system of claim 9, further comprising a waste drain adaptor configured to removably couple to the waste end and a waste drain pipe.

11. The system of claim 10, wherein the substrate is a continuous structure the size of the shower floor formed with a slope from the substrate edges to the drain opening.

12. The system of claim 11, wherein the slope is one-half inch per foot of distance from the drain opening.

13. The system of claim 9, wherein the waterproofing membrane seamlessly bonding material covers extends to the outer edges of the substrate.

14. A method for producing a shower base drain, the method comprising:
forming a substrate that encompasses an outer portion of a flange of a bonding flange drain wherein a portion of the substrate extends under the flange and wherein the flange defines a drain surface and defines a drain opening;
coupling the substrate and the bonding flange drain with a waterproof adhesive;
attaching a waterproofing membrane with a waterproofing cement to the substrate from the drain opening over the substrate;
forming a drain tube with an inner rim, the drain tube operable to removably seal with the lower end of the bonding flange drain using a coupling interface, and a waste end opposite the coupling interface.

15. The method of claim 14, wherein the coupling interface is a silicon ring coupled to either the inside of the drain tube or the outside of the lower drain end.

16. The system of claim 14, wherein the waterproofing membrane is a polypropylene includes a fibrous material mesh extending from both sides of the polypropylene.

17. The system of claim 16, wherein the bonding material is a waterproof polyurethane cement.

18. The system of claim 14, further comprising a waterproof adhesive bonding the flange to the substrate.

19. The system of claim 14, wherein the substrate is a graphite infused polystyrene foam.

20. A drain system comprising:
a bonding flange drain comprising a flange defining a drain surface and defining a drain opening, a lower drain end and a tubular structure between the drain opening and the lower drain end;
a substrate comprised of a graphite infused polystyrene infused foam that encompasses the outer portion of the flange and extending under the flange and is bonded to the flange with a waterproof adhesive, wherein the substrate is the size of the shower floor, and wherein substrate is a continuous structure formed with a slope of one-half inch drop per foot of distance from the substrate edges to the drain opening;
a polypropylene waterproofing membrane having a fibrous material mesh coupled to and extending from both sides of the membrane and a polyurethane cement coupling the substrate and the drain surface up to the boundary of the drain opening to the edge of the substrate;
a drain tube with an inner rim, the drain tube operable to removably seal with the lower end of the bonding flange drain using a silicon ring coupled to either the inside of the drain tube or the outside of the lower drain end;
an adaptor threaded on outside configured to engage the tubular structure;
an adjustable height drain configured to engage the adaptor; and
a waste drain adaptor configured to removably couple to the waste end and a waste drain pipe.
